(19) United States
(12) Patent Application Publication
(10) Pub. No.: US 2026/0073450 A1
(43) Pub. Date: Mar. 12, 2026

(54) SYSTEM AND METHOD FOR DETERMINISTICALLY GENERATING REPRODUCIBLE EVALUATIVE SCORES FOR A SUBJECT OF ANALYSIS

(71) Applicant: Bryan Hughes, Palm Springs, CA (US)

(72) Inventors: Bryan Hughes, Palm Springs, CA (US); Chad Spitler, San Francisco, CA (US)

(73) Assignee: VIAlab Inc., Palm Springs, CA (US)

(21) Appl. No.: 19/394,941

(22) Filed: Nov. 20, 2025

(51) Int. Cl. G06Q 40/06; G06Q 30/018

(52) U.S. Cl. CPC G06Q 40/0631; G06Q 30/018

(57) ABSTRACT

The present invention relates to a system and method for deterministically generating reproducible evaluative scores for a subject of analysis (e.g., a security). The system comprises a processor and memory storing instructions to: receive verified data describing the subject; store this data in a fixed and version-controlled corpus to define a static analytical context; execute a large-language model (LLM) under a structured prompt framework that directs a controlled scratch-pad reasoning process for preliminary interpretations and evidence extraction; perform a multi-pass deterministic analysis of the fixed corpus to produce structured, synthesized statements as reproducible evidentiary outputs; and finally, apply a rubric-based scoring engine that converts these statements into calibrated alignment scores and aggregates them to generate a composite deterministic score. This architecture ensures reproducibility, transparency, and auditability by anchoring the flexible analysis of the LLM and the final scoring logic to a known, unchanging evidence corpus.

### FIELD OF THE INVENTION

The present invention relates to the field of advanced computational techniques, and more particularly to a system and method for deterministically generating reproducible evaluative scores for a subject of analysis, enabling audit-ready, reproducible, and transparent ESG-financial scoring through deterministic inference, version-controlled data context, and provenance metadata that strengthens regulatory compliance, investor trust, and cross-entity comparability.

### Background

### Interpretation Considerations

This section provides a detailed description of the technical field and discusses the problems encountered within it. Therefore, statements in the section are not to be construed as prior art.

### Discussion

The field of investment analysis is evolving with advancements in data processing and automation, enabling more efficient evaluation of securities. Traditional methods rely on manual assessment of financial statements, regulatory filings, and sustainability disclosures, which are labor-intensive and slow. These approaches hinder timely decision-making and limit the scope of analysis across large universes of securities. As financial markets generate increasing volumes of structured and unstructured data, there is a growing need for systems that can process information rapidly and on a large scale.

Existing techniques for evaluating investment securities involve significant manual effort to extract and interpret data from disparate sources. Analysts must review extensive documentation, including annual reports, Environmental, Social, and Governance (ESG) disclosures, and compliance filings, to assess a company's financial and sustainability profile. This process is not only time-consuming but also susceptible to inconsistencies and subjective judgment. The reliance on human intervention increases operational costs and reduces the frequency with which portfolios can be reassessed.

The cost and duration of conventional analysis make it impractical to regularly evaluate large numbers of securities. Firms often dedicate months and substantial resources to analyzing a limited set of investments, creating inefficiencies and delays. This restricts the ability to monitor dynamic market conditions or respond promptly to emerging risks and opportunities. Smaller institutions and individual investors are particularly disadvantaged due to limited access to specialized expertise and analytical tools.

Scalability remains a critical limitation in current investment evaluation frameworks. Conventional systems struggle to efficiently process the growing volume of ESG and financial data from diverse sources, including alternative data streams like news, satellite imagery, and social media. Without automated, scalable solutions, firms cannot maintain up-to-date assessments across global markets. The inability to integrate real-time data impedes the implementation of proactive portfolio management and risk mitigation strategies.

Conventional ESG ratings depend heavily on self-reported corporate data, which may be incomplete, selectively disclosed, or subject to bias. Companies have discretion over what information to publish, increasing the risk of greenwashing and misrepresentation. The absence of independent verification further undermines the credibility of these ratings. As a result, investors may base decisions on inaccurate or misleading assessments of a company's sustainability performance.

ESG rating methodologies lack standardization, leading to significant variations in scores across providers. Each agency employs distinct criteria, weightings, and data sources, leading to inconsistent evaluations of the same entity. This divergence creates confusion for investors who attempt to compare companies or benchmark their performance. Without harmonized frameworks, ESG ratings lack reproducibility and scientific rigor, limiting their utility in objective decision-making.

Transparency in ESG scoring is limited, as many rating agencies treat their models as proprietary and do not disclose detailed calculation methods. Investors often struggle to understand how scores are derived, or which factors carry the most weight. This opacity prevents validation of results and raises concerns about potential biases or arbitrary assumptions embedded in the scoring process. Without clear explanations, stakeholders cannot assess the reliability or relevance of the ratings.

A weak correlation between traditional ESG ratings and actual financial performance reduces investor confidence in their predictive value. While some studies suggest that sustainable practices offer long-term benefits, empirical evidence remains inconsistent across various sectors and time periods. This discrepancy may stem from methodological flaws, inclusion of non-material factors, or misalignment between reported metrics and economic outcomes. As a result, the financial materiality of ESG ratings remains uncertain.

There is a need for improved systems and methods that automate the evaluation of investment securities using objective, transparent, and standardized data analysis techniques. Such systems should reduce reliance on manual processes, enhance scalability, and incorporate verified, real-time data sources to improve accuracy and timeliness. A more consistent, reproducible, and transparent approach to ESG and financial assessment would enable better-informed investment decisions and increase trust in the sustainability metric.

### SUMMARY

An objective of the present invention is to provide a system and method for deterministically generating reproducible evaluative scoring of a subject of analysis. This system delivers a deterministic, reproducible composite sustainability and financial score by constraining analysis to a fixed, version-controlled corpus. The system further uses a standardized prompt framework and deterministic LLM inference parameters suitable for audit replay and regulatory scrutiny.

Another objective of the present invention is to provide a system and method that offers end-to-end traceability through machine-readable provenance, linking every pillar level and composite score to specific corpus passages, rubric elements, and evaluation context, thereby enabling transparent verification and effective auditor review.

Another objective of the present invention is to provide a system and method that enables investor-facing analytics for portfolio construction, benchmarking, and comparative visualization. This system consistently identifies leaders and laggards across entities and over time using the composite and pillar scores.

Still another objective of the present invention is to provide a system and method that cross-validates stated corporate intentions against demonstrated actions, violations, and legal cases.

Still another objective of the present invention is to provide a system and method for producing a train of reasoning that yields explainable, user-interpretable scoring outputs.

This and other objectives are achieved by providing a system and method for deterministically generating reproducible evaluative scores for a subject of analysis, as defined by the features of the independent claims. Additional advantageous embodiments and improvements of the invention are listed in the dependent claims. The use of expressions like “ . . . aspect according to the invention” or “in one embodiment” or similar terminology is intended to refer to examples or embodiments consistent with the broadest scope of the invention as defined by the independent claims.

According to a first aspect, the present invention discloses a computer-implemented method for deterministically generating reproducible evaluative scores for a security. The method comprising the steps of: a) receiving verified data describing the security, the data including at least one of financial, regulatory, sustainability or accredited third-party information; b) storing the verified data in a fixed and version-controlled corpus, defining a static analytical context that maintains a known universe of evidence for evaluation; c) executing, by one or more processors, a large-language model (LLM) operating under a structured prompt framework that applies a rubric hierarchy organizing evaluation questions by asset class, theme, and topic aligned to plural pillars, including Values, Impact, Analysis, Alignment, Activism, and Financial Performance, and directing a controlled scratch-pad reasoning process that records intermediate reasoning data representing extracted evidence and preliminary interpretations; d) performing a multi-pass deterministic analysis of the fixed corpus, including identification of stated intentions, demonstrated actions, contradictions or violations, and remediation actions, the passes producing structured, synthesized statements as reproducible evidentiary outputs; e) applying a rubric-based scoring engine that converts the synthesized statements into calibrated alignment scores within a defined numeric range and aggregates the scores across the pillars to produce a composite deterministic score; and f) outputting the composite score and provenance metadata through an analytic interface supporting at least one of deterministic portfolio filtering, benchmarking, research-goal extension, and visualization of entities along financial-return and sustainability-alignment axes. The method is transparent and audit-ready, providing scoring with reliable traceability to underlying data sources.

In an embodiment of the present invention, the structured prompt framework directs the large-language model through ordered analytical stages, including context interpretation, evidence extraction, intermediate reasoning recording, and rubric application. This framework enhances reliability and regulatory acceptance by guiding the LLM through a sequence of analytical stages.

In another embodiment of the present invention, the scratch-pad reasoning process generates intermediate reasoning records comprising extracted evidence, contextual justification, and preliminary scoring rationale as structured data objects, providing enhanced reproducibility, the ability to audit or compare evaluations across different time periods, and the ability to justify and explain every intermediate step in the scoring process.

In another embodiment of the present invention, the multi-pass deterministic analysis includes at least four passes, respectively identifying stated intentions, demonstrated actions, contradictions or violations, and remediation actions, each pass producing synthesized statements traceable to corpus sources. The multi-pass deterministic analysis provides a structured, comprehensive evaluation that covers all significant dimensions of corporate responsibility and performance.

In another embodiment of the present invention, the rubric-based scoring engine applies calibration logic defining fixed numeric thresholds that classify alignment scores into negative, neutral, and positive zones to ensure reproducible classification outcomes. This reduces variability between outputs for similar inputs.

In another embodiment of the present invention, the provenance metadata includes identifiers for corpus version, rubric element, prompt-framework version, and timestamp to permit reconstruction of prior evaluations. This reduces cognitive load and provides enhanced efficiency.

In yet another embodiment of the present invention, the fixed corpus is maintained as a version-controlled dataset updated on defined validation cycles that preserve historical analytical contexts and deterministic reproducibility. This encourages disciplined reasoning, leading to more logically coherent outputs.

In yet another embodiment of the present invention, the analytic interface further generates additional rubric questions or topics under the same structured prompt framework in response to user-defined research goals while maintaining deterministic reproducibility. This improves adaptability and provides enhanced decision support for a broad range of financial market participants.

In yet another embodiment of the present invention, the analytic interface renders a visualization of evaluated entities along financial-return and sustainability-alignment dimensions to identify comparative positioning and substitution opportunities within portfolios. This facilitates training and provides actionable insights for portfolio optimization and strategic benchmarking.

In yet another embodiment of the present invention, the method further comprises verifying rubric balance and output stability using expert-defined bias-control criteria to confirm consistency of deterministic scoring results. This provides a verifiable consistency, essential for compliance and audit readiness.

According to a second aspect, the present invention discloses a system for deterministically generating reproducible evaluative scores for a subject of analysis. The system comprises one or more processors and a memory. The memory is coupled with the processors. The memory storing instructions that, when executed by the processors, cause the processors to: a) receive verified multi-modal data describing the subject; b) store the verified source information in a fixed and version-controlled corpus, defining a static analytical context that maintains a known universe of evidence for evaluation; c) execute a large-language model (LLM) under a structured prompt framework that organizes evaluation questions, and directs a controlled scratch-pad reasoning process that records intermediate reasoning data representing extracted evidence and preliminary interpretations; d) perform a multi-pass deterministic analysis of the fixed corpus to produce structured, synthesized statements as reproducible evidentiary outputs; e) apply a rubric-based scoring engine that converts the synthesized statements into calibrated alignment scores within a defined numeric range and aggregates the scores to produce a composite deterministic score; and f) output the composite score and provenance metadata through an analytic interface. The system provides an integrated, repeatable scoring operation suitable for automated evaluation and intelligent analytics.

In an embodiment of the present invention, the instructions configure the processors to direct the large-language model through ordered analytical stages, including context interpretation, evidence extraction, intermediate reasoning recording, and rubric application. This framework provides increased reliability and regulatory acceptance by guiding the LLM through sequential analytical stages.

In an embodiment of the present invention, the instructions configure the processors to generate and store intermediate reasoning records comprising extracted evidence, contextual justification, and preliminary scoring rationale as structured data objects, providing enhanced reproducibility, the ability to audit or compare evaluations across different time periods, and the ability to justify and explain every intermediate step in the scoring process.

In an embodiment of the present invention, the instructions configure the processor to perform a multi-pass deterministic analysis, including at least four passes respectively identifying stated intentions, demonstrated actions, contradictions or violations, and remediation actions, each pass producing synthesized statements traceable to corpus sources. The multi-pass deterministic analysis provides a structured, comprehensive evaluation that covers all significant dimensions of corporate responsibility and performance.

In an embodiment of the present invention, the instructions configure the processor to apply calibration logic defining fixed numeric thresholds that classify alignment scores into negative, neutral, and positive zones to ensure reproducible classification outcomes. This reduces variability between outputs for similar inputs.

In an embodiment of the present invention, the instructions configure the processor to generate provenance metadata, including identifiers for corpus version, rubric element, prompt-framework version, and timestamp, to permit reconstruction of prior evaluations. This reduces cognitive load and provides enhanced efficiency.

In another embodiment of the present invention, the instructions configure the processor to maintain the fixed corpus as a version-controlled dataset updated according to periodic validation cycles that preserve historical analytical contexts. This encourages disciplined reasoning, leading to more logically coherent outputs.

In another embodiment of the present invention, the instructions configure the processor to generate additional rubric questions or topics under the same structured prompt framework in response to user-defined research goals while maintaining deterministic reproducibility. This improves adaptability and provides enhanced decision support for a broad range of financial market participants.

In another embodiment of the present invention, the instructions configure the processor to render a visualization of evaluated entities along financial-return and sustainability-alignment dimensions to identify comparative positioning and substitution opportunities within portfolios. This facilitates training and provides actionable insights for portfolio optimization and strategic benchmarking.

In yet another embodiment of the present invention, the instructions configure the processor to integrate deterministic scoring outputs with portfolio construction, compliance auditing, or investment-screening applications executed within an external analytics environment. This enables automated, data-driven decision-making within existing financial workflows.

In yet another embodiment of the present invention, the instructions configure the processor to provide an audit interface enabling retrieval of synthesized statements and provenance metadata in human-readable form for regulatory or stakeholder verification. This significantly simplifies and strengthens regulatory or stakeholder verification processes.

In yet another embodiment of the present invention, the instructions configure the processor to execute the structured prompt framework across distributed computing resources while maintaining deterministic reproducibility across executions. This ensures reliable and consistent results regardless of the underlying computational environment.

In yet another embodiment of the present invention, the instructions configure the processor to manage corpus version governance by archiving prior corpus states and invalidating dependent evaluations when a new corpus version is introduced. This provides a reliable scoring and assessment that can be independently reproduced and verified.

In still another embodiment of the present invention, the instructions configure the processor to record and display reproducibility metrics quantifying variance across repeated executions of identical evaluations. This facilitates training and benchmarking by providing a clear structure for evaluating and comparing model performance across reasoning steps.

In still another embodiment of the present invention, the instructions configure the processor to verify rubric balance and output stability using expert-defined bias-control criteria and automatically log corresponding consistency assessments within the provenance metadata. This provides a verifiable consistency, essential for compliance and audit readiness.

According to a third aspect, the present invention discloses a system for generating evaluative scores for a subject of analysis. The system comprises one or more processors and a memory. The memory stores instructions that, when executed by the processors, cause the processors to: a) receive verified data describing the subject; b) store the verified source information in a fixed and version-controlled corpus, defining a static analytical context that maintains a known universe of evidence for evaluation; c) execute a large-language model (LLM) under a structured prompt framework that organizes evaluation questions, and directs a controlled scratch-pad reasoning process that records intermediate reasoning data representing extracted evidence and preliminary interpretations; d) perform a multi-pass deterministic analysis of the fixed corpus to produce structured, synthesized statements as reproducible evidentiary outputs; and e) apply a rubric-based scoring engine that converts the synthesized statements into calibrated alignment scores within a defined numeric range and aggregates the scores to generate the composite score. This system achieves reproducibility and auditability by anchoring the LLM's flexible analysis to a fixed, version-controlled corpus and a deterministic, rubric-based scoring engine.

### BRIEF DESCRIPTION OF DRAWINGS

FIG. 1(A) illustrates a system for deterministically generating reproducible evaluative scores for a subject of analysis in accordance with an exemplary embodiment of the present invention;

FIG. 1(B) illustrates a system for deterministically generating reproducible evaluative scores for a subject of analysis in accordance with another exemplary embodiment of the present invention;

FIG. 2 illustrates a method for generating reproducible evaluative scores for a security in accordance with an exemplary embodiment of the present invention;

FIG. 3 illustrates a hierarchical diagram of the rubric framework, organized by asset class, theme, topic, and pillars such as Values, Impact, Analysis, Alignment, Activism, and Financial Performance in accordance with an exemplary embodiment of the present invention;

FIG. 4 illustrates a scratch-pad reasoning and scoring module in accordance with an exemplary embodiment of the present invention;

FIG. 5 illustrates a multi-pass deterministic analysis subsystem that processes a fixed, version-controlled corpus to generate structured, source-traceable synthesized statements across ordered analytical passes to support the reproducibility and auditability of evaluative outcomes in accordance with an exemplary embodiment of the present invention;

FIG. 6 illustrates a rubric-based scoring subsystem configured to convert the synthesized statements generated by the multi-pass analysis into calibrated alignment scores within a defined numeric range in accordance with an exemplary embodiment of the present invention;

FIG. 7 illustrates a screenshot of flow between a provenance and metadata module and an analytic interface module that records, for each evaluation, identifiers and relationships sufficient to reconstruct the evidence, activities, agents, methodologies, and configurations involved in producing synthesized statements and scores in accordance with an exemplary embodiment of the present invention;

FIG. 8 illustrates an analytic interface module that consumes pillar-level and composite scores, along with provenance links, to enable portfolio filtering, benchmarking, research goal extension, and two-dimensional positioning of entities along financial return and sustainability alignment axes in accordance with an exemplary embodiment of the present invention;

FIG. 9 illustrates a determinism control and verification subsystem that enforces, records, and monitors inference and scoring configurations to achieve run-to-run identical outputs for identical inputs in accordance with an exemplary embodiment of the present invention;

FIG. 10 illustrates a governance controller that manages versioned snapshots of the fixed corpus through lifecycle, preserving the analytical context used in any evaluation and preventing retroactive mutation of evidence in accordance with an exemplary embodiment of the present invention;

FIG. 11 illustrates integration endpoints that expose composite and pillar-level scores, classifications, and provenance links to external portfolio construction, compliance auditing, and investment screening systems in accordance with an exemplary embodiment of the present invention;

FIG. 12 illustrates a screenshot of an analytic interface module, showcasing a compass, in accordance with an exemplary embodiment of the present invention;

FIG. 13 illustrates a screenshot of an analytic interface module, showcasing my portfolios in accordance with an exemplary embodiment of the present invention;

FIG. 14 illustrates a screenshot of an analytic interface module, showcasing the performance tab of the selected portfolio in accordance with an exemplary embodiment of the present invention;

FIG. 15 illustrates a screenshot of an analytic interface module showcasing research goals for defining and discovering community-shared research goals in accordance with an exemplary embodiment of the present invention;

FIG. 16 illustrates a screenshot of an analytic interface module showcasing notebooks in accordance with an exemplary embodiment of the present invention;

FIG. 17 illustrates a screenshot of an analytic interface module showcasing a human rights watchlist selected from notebooks in accordance with an exemplary embodiment of the present invention;

FIG. 18 illustrates a screenshot of an analytic interface module showcasing Alphabet Inc. analysis in accordance with an exemplary embodiment of the present invention;

FIG. 19 illustrates a screenshot of an analytic interface module showcasing a prompt history in accordance with an exemplary embodiment of the present invention;

FIG. 20 illustrates a screenshot of an analytic interface module showcasing one or more securities in accordance with an exemplary embodiment of the present invention;

FIG. 21 illustrates a screenshot of an analytic interface module showcasing a detailed security profile for Apple Inc. in accordance with an exemplary embodiment of the present invention; and

FIG. 22 illustrates a screenshot of an analytic interface module showcasing a dashboard providing quick access to core functions via action cards in accordance with an exemplary embodiment of the present invention.

### DETAILED DESCRIPTION OF DRAWINGS

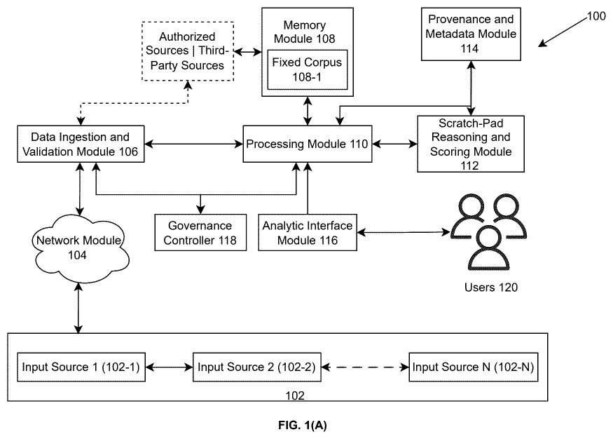

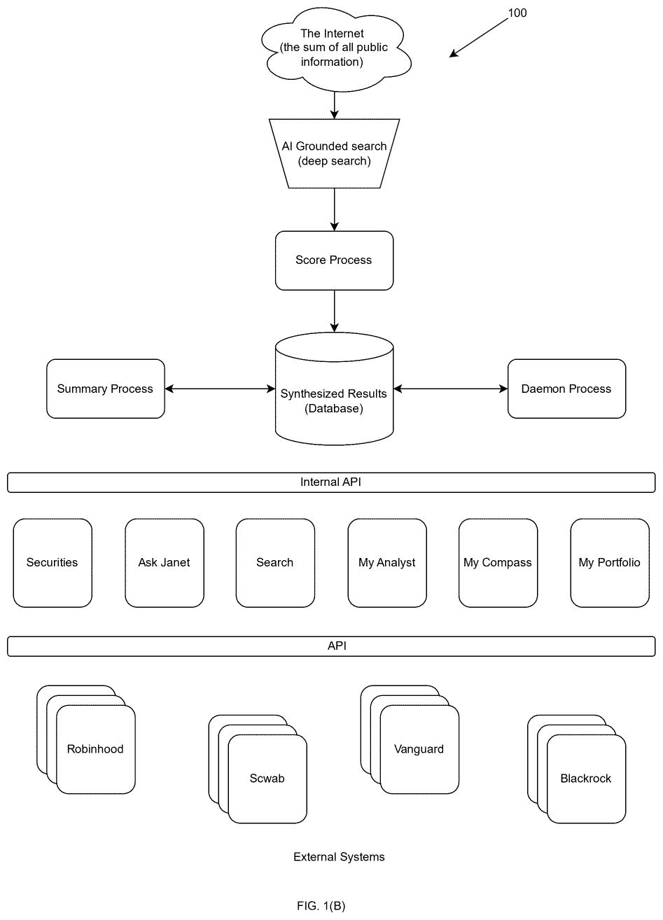

FIG. 1(A) illustrates a system 100 for deterministically generating reproducible evaluative scores for a subject of analysis in accordance with an exemplary embodiment of the present invention. The system 100 comprises an input source 102, a network module 104, a data ingestion and validation module 106, a memory module 108, a processing module 110, a scratch-pad reasoning and scoring module 112, a provenance and metadata module 114, an analytic interface module 116, a governance controller 118, and one or more users 120.

The system 100 begins by receiving verified data describing the security or subject of analysis from one or more input sources 102 (102-1, 102-2, . . . , 102-N). The input sources 102 include, but are not limited to, credible and third-party sources. This crucial initial data related to the subject includes but is not limited to verified environmental, social, and governance (ESG) disclosures (for example, sustainability reports following Global Reporting Initiative (GRI) standards), financial statements (for example, annual reports, 10-K filings), regulatory filings (for example, securities and exchange commission (SEC) disclosures), and various forms of accredited third-party information (for example, morgan stanley capital international (MSCI) ratings, Bloomberg ESG scores). This comprehensive data, encompassing financial, regulatory, sustainability, or other relevant accredited information, forms the factual basis for subsequent evaluation.

In one case, the system 100 (as shown in FIG. 1(B)) may support a multi-layered architecture that integrates a grounded AI search engine leveraging public internet data or deep search and collection of additional relevant information 102. This AI-grounded search facilitates expanded evidence gathering beyond static input sources, feeding results through a rigorous validation and versioning process before their integration into the synthesized results database in the fixed corpus 108-1 for inclusion in a subsequent, deterministically reproducible evaluation.

The data from the diverse input sources 102 is securely transmitted throughout the system's 100 architecture via the network module 104. The network module 104 used for communication support any number of suitable wireless data communication protocols, techniques, or methodologies, including radio frequency (RF), infrared (IrDA), Bluetooth, ZigBee (and other variants of the IEEE 10 802.15 protocol), a wireless fidelity (Wi-Fi) or IEEE 802.11 (any variation), IEEE 802.16 (WiMAX or any other variation), global apparatus for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication. The network module 104 ensures efficient and reliable data transfer by using appropriate network protocols to maintain data integrity during transmission.

The data ingestion and validation module 106 receives and processes the data using the network module 104. The data ingestion and validation module 106 is tasked with acquiring and rigorously confirming the integrity and provenance of the data. The data ingestion and validation module 106 performs checksums to detect corruption, validates data against predefined schemas (for example, JavaScript Object Notation (JSON) schema for ESG metrics), cross-references entities against trusted master databases, and confirms that the data originates from authorized repositories (for example, direct feeds from financial data providers, official government databases). This rigorous validation step is crucial for establishing the trustworthiness of the analytical context and ensuring the quality of the evidence.

The validated data is then securely stored within the memory module 108, specifically as a fixed corpus 108-1. The fixed corpus 108-1 is maintained as a version-controlled, static dataset, providing a precise, unchanging analytical context for any given evaluation. For example, a corpus might be labeled “2023Q4_ESG_Corpus_v2.1”, capturing all validated data up to a specific quarter and version. By preserving a known universe of evidence, the system 100 ensures deterministic reproducibility, and running the same analysis on the same corpus version will always yield identical results. The fixed corpus 108-1 is consistently updated through periodic validation cycles that meticulously preserve historical analytical contexts, enabling the reconstruction of past evaluations. The memory module 108 may include any of the volatile memory elements (for example, random access memory, such as DRAM, SRAM, SDRAM, etc.), non-volatile memory elements (for example, ROM, hard drive, etc.), magnetic, semiconductor, tape, optical, removable, non-removable, or other types of storage device or tangible and combinations thereof. Typical forms of non-transitory media include, for example, a flash drive, a flexible disk, a hard disk, a solid state drive, magnetic tape or other magnetic data storage medium, a CD-ROM or other optical data storage medium, any physical medium with patterns of holes, a non-transitory computer-readable medium, RAM, a PROM, and EPROM, a FLASH-EPROM, other flash memory, NVRAM, a cache, a register, other memory chip or cartridge, or networked versions of the same. The memory module 108 may have a distributed architecture, with various components located remotely from one another but accessible to the processing module 110. Alternatively, the memory module 108 may be placed locally or remotely, depending upon the type of the processing module 110. The memory module 108 can include one or more software programs, or algorithms, each of which includes an ordered listing of executable instructions for implementing logical functions. The memory module 108 stores instructions that, when executed by the processing module 110 (one or more processors), cause the system to perform the overall operation of the system 100.

The synthesized results of FIG. 1(B), organized within a dedicated database (memory module 108), are subject to periodic summary and daemon processes, supporting both scheduled reporting (summary process) and automated background workflows (daemon process). These processes operate in parallel to the main analytic engine, enriching, refining, and maintaining the synthesized results over time, allowing for efficient output and retrieval of the reproducible evidentiary outputs.

The core analytical engine resides within the processing module 110. The processing module 110 orchestrates the execution of a large-language model (LLM) under a highly structured prompt framework. This framework is designed to apply a detailed rubric hierarchy, organizing evaluation questions systematically by asset class (for example, public equities, corporate bonds), theme (for example, climate change resilience, human capital management), and specific topic (for example, scope 1 & 2 carbon emissions, supply chain labor practices). These questions are meticulously aligned to plural analytical pillars, including Values, Impact, Analysis, Alignment, Activism, and Financial Performance. The prompt framework directs the LLM through ordered analytical stages, such as context interpretation (understanding the prompt), evidence extraction (finding relevant text in the corpus), intermediate reasoning recording, and precise rubric application, thereby initiating and guiding a controlled scratch-pad reasoning process. For scalability and efficiency, the system 100 may execute this structured prompt framework across distributed computing resources (for example, cloud-based parallel processing clusters using containerized LLM instances), while strictly maintaining deterministic reproducibility across all executions.

The processing module 110 is coupled with the memory module 108. The processing module 110 serves as the central operational core, managing the overall functionality and control of all modules within the system 100. It orchestrates the entire process, from directing the data ingestion and validation module 106 to processing incoming data to executing the large-language model within the structured prompt framework and ultimately controlling the multi-pass deterministic analysis and the rubric-based scoring engine. By executing the instructions stored in the memory module 108, the processing module 110 ensures the sequential, deterministic operation necessary to generate reproducible evaluative scores. The processing module 110 may comprise a single or multi-core processor. The processing module 110 executes software instructions or algorithms to implement functional aspects of the present invention. The processing module 110 may also be implemented as a digital signal processor (DSP), a microcontroller, a dedicated system-on-chip (SoC), an integrated circuit implemented with a field-programmable gate array (FPGA), an application-specific integrated circuit (ASIC), or a combination thereof. The processing module 110 may be implemented using a co-processor for complex computational tasks. The processing module 110 utilizes stored logic to execute and control any number of operations simultaneously. The processing module 110 may include one or more specialized hardware, software, and/or firmware modules (not shown) specially configured with particular circuitry, instructions, algorithms, or data to perform functions of the disclosed methods. The processing module 110 may be a general-purpose computer processor that executes commands or instructions but may utilize any of a wide variety of other technologies, including special-purpose hardware, a microcomputer, mini-computer, mainframe computer, programmed micro-processor, micro-controller, peripheral integrated circuit element, a customer-specific integrated circuit (CSIC), a logic circuit, a programmable logic device (PLD), a programmable logic array (PLA), RFID processor, smart chip, or any other device or arrangement of devices that are capable of implementing the operations of the processes of embodiments of the system 100.

The scratch-pad reasoning and scoring module 112 performs the critical multi-pass inference, evidence synthesis, and rubric-based scoring. The scratch-pad reasoning and scoring module 112 executes the controlled scratch-pad reasoning process, meticulously recording intermediate reasoning data that captures extracted evidence and preliminary interpretations. For example, if evaluating a company's climate strategy, an intermediate record might include a direct quote from an annual report (“Company X commits to net-zero emissions by 2050”) as extracted evidence, along with a contextual justification (“This statement reflects a stated intention regarding climate action”) and a preliminary scoring rationale (for example, “Positive for intention, awaiting action verification”) as structured data objects. The scratch-pad reasoning and scoring module 112 module performs a multi-pass deterministic analysis of the fixed corpus, including at least four distinct passes:

Pass 1: Identifying Stated Intentions: For example, extracting declarations like “Our goal is to reduce water consumption by 20% by 2030”.

Pass 2: Identifying Demonstrated Actions: For example, finding evidence of actual investments or projects like “Company X invested $50 million in new water recycling facilities in 2022”.

Pass 3: Identifying Contradictions or Violations: For example, identifying news reports or regulatory fines indicating “Company X received a penalty for excessive water discharge in Q1 2023”.

Pass 4: Identifying Remediation Actions: For example, detecting plans or efforts to address identified issues, such as “Company X announced a new treatment facility to prevent future discharge violations”.

Each pass produces structured, synthesized statements (for example, “Company X has a stated intention to reduce water consumption (verified by 2030 target in sustainability report”) as reproducible evidentiary outputs, each traceable back to its specific source within the corpus.

Subsequently, a rubric-based scoring engine converts these synthesized statements into calibrated alignment scores within a defined numeric range (for example, a scale from −5 to +5 or 0 to 100). The rubric-based scoring engine applies robust calibration logic, defining fixed numeric thresholds that classify alignment scores into negative, neutral, and positive zones (for example, a “Carbon Emissions” score of 80-100 is “Positive”, 40-79 is “Neutral”, and below 40 is “Negative”). This ensures consistent and reproducible classification outcomes across all evaluations. Finally, the rubric-based scoring engine aggregates these scores across the defined analytical pillars to produce a comprehensive, deterministic composite score.

To ensure ultimate transparency, auditability, and traceability, the provenance and metadata module 114 generates detailed machine-readable provenance for every score. This provenance links each composite score, and even individual alignment scores, directly to the specific corpus evidence that supported it and the exact rubric element used in its derivation. The provenance metadata includes vital identifiers such as the corpus version ID (for example, “2023Q4_ESG_Corpus_v2.1”), the specific rubric element ID (for example, “Environmental/Water Management/Target Setting”), the prompt-framework version (for example, “VIA3_WaterRisk_v1.0”), and a timestamp of the evaluation. This rich metadata enables the complete reconstruction of prior evaluations, thereby verifying and fostering trust. The system 100 also provides an audit interface that allows the retrieval of these synthesized statements and provenance metadata in human-readable form, which is crucial for regulatory compliance or stakeholder verification. Furthermore, consistency assessments derived from bias-control verification are automatically logged within the provenance metadata, providing an additional layer of assurance.

The analytic interface module 116 serves as the primary gateway for analysts and applications to interact with the system 100. The analytic interface module 116 intuitively presents the composite scores, detailed reasoning traces, and the comprehensive provenance data. The analytic interface module 116 supports a variety of advanced functionalities:

Portfolio Filtering: The one or more users 120 may filter their investment universe, for example, “Show all companies with a positive climate alignment score and market capitalization over $10 billion”.

Benchmarking: Analysts may benchmark a specific company's performance against industry peers, such as “Compare Company A's labor practices score against the average of the S&P 500 tech sector”.

Research-Goal Extension: The system 100 allows the users 120 to generate additional rubric questions or topics under the same structured prompt framework in response to evolving user-defined research goals (for example, “Investigate supply chain resilience for companies with high water risk”), all while maintaining deterministic reproducibility.

Visualization: The analytic interface module 116 renders powerful visualizations, such as a scatter plot of evaluated entities along financial-return and sustainability-alignment dimensions, helping identify comparative positioning (for example, “Leaders” in both metrics) and potential substitution opportunities within portfolios.

In one scenario, the system 100 architecture, as shown in the FIG. 1(B) includes an explicit separation between internal APIs (serving modules such as Securities, Ask Janet, Search, My Analyst, My Compass, and My Portfolio) and external APIs, allowing for robust interconnection with third-party external systems (including Robinhood, Schwab, Vanguard, BlackRock, and others). This enables seamless data exchange, result delivery, and analytic integration with a diverse ecosystem of financial and research platforms.

The synthesized results within the database not only power the scoring and analysis modules but are also continuously enhanced by background summary and daemon routines, maximizing system 100 responsiveness, knowledge enrichment, and operational resilience.

This layered API structure helps maintain strict separation between internal logic, user-facing functions, and external integrations, supporting modularity, extensibility, and security within the system's 100 overall design.

The deterministic scoring outputs can be seamlessly integrated with external analytics environments for sophisticated applications, including portfolio construction, compliance auditing, or investment screening tools. Moreover, the interface records and displays crucial reproducibility metrics, quantifying variance (for example, showing a “run-to-run variance of <0.01%” for a specific score over repeated executions), thereby reinforcing confidence in the system's 100 deterministic nature.

The governance controller 118 is responsible for overseeing critical system 100 operations and maintaining overall integrity. The governance controller 118 manages corpus version governance by archiving prior corpus states (for example, maintaining “2023Q3_ESG_Corpus_v2.0” when “2023Q4_ESG_Corpus_v2.1” is introduced) and intelligently invalidating dependent evaluations when a new corpus version is released, ensuring that all analyses are traceable to a specific, immutable dataset. The governance controller 118 also conducts rigorous bias-control verification, utilizing expert-defined criteria to verify rubric balance and output stability. For example, the governance controller 118 may involve expert review of rubric weighting for specific ESG criteria (for example, “gender diversity scores”) to prevent unintended biases or automatically logging consistency assessments after running tests on diverse, representative datasets. Additionally, the governance controller 118 manages overall system 100 configuration, including LLM model parameters, API keys, and access controls, ensuring the consistent, secure, and robust operation of the VIA3 deterministic inference system 100.

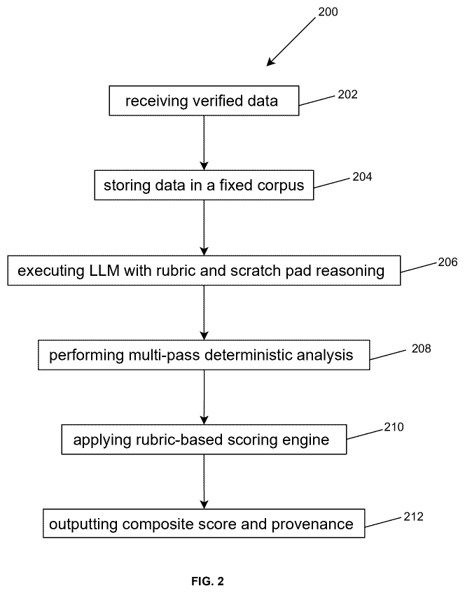

FIG. 2 illustrates a method 200 for generating reproducible evaluative scores for a security in accordance with an exemplary embodiment of the present invention. The method 200 comprises the following steps:

a) Receiving Verified Data (Step 202): The method 200 begins by receiving 202 verified data describing the security or subject of analysis. This data includes at least one of the financial, regulatory, sustainability, or accredited third-party information. Data sources may include direct submissions, aggregated APIs, and accredited databases that encompass annual reports, regulatory filings, ESG disclosures, and authoritative ratings, all of which underpin a trusted analytical context.

b) Storing Data in a Fixed Corpus (Step 204): The received verified data is stored in a fixed and version-controlled corpus. This corpus defines a static analytical context, maintaining a known universe of evidence for evaluation. The version-controlled nature of the corpus ensures that any subsequent evaluation is reproducible and traceable to a particular data set and analytical state. The corpus is updated only by defined cycles, preserving historical context and enabling reconstruction of all prior evaluations.

c) Executing LLM with Rubric and Scratch-Pad Reasoning (Step 206): One or more processors then execute a large-language-model (LLM) under a structured prompt framework. This framework applies a rubric hierarchy that organizes evaluation questions by asset class, theme, and topic, all aligned to plural evaluation pillars, including Values, Impact, Analysis, Alignment, Activism, and Financial Performance. The LLM is systematically guided through analytical stages, including context interpretation, evidence extraction, recording of intermediate reasoning, and rubric application. During this step 206, a controlled scratch-pad reasoning process records all extracted evidence, contextual justification, and preliminary interpretations as structured data objects, building a transparent, reproducible record of intermediate reasoning and scoring rationale.

d) performing multi-pass deterministic analysis (Step 208): A multi-pass deterministic analysis is performed on the fixed corpus to support reproducibility further. The method 200 includes at least four passes, each designed to identify stated intentions, demonstrated actions, contradictions or violations, and remediation actions. Each analytical pass yields structured, synthesized statements that serve as reproducible evidentiary outputs traceable to their respective corpus sources.

e) applying a rubric-based scoring engine (Step 210): The method 200 follows applies a rubric-based scoring engine that converts the synthesized statements into calibrated alignment scores within a defined numeric range. The rubric-based scoring engine applies calibration logic that defines fixed numeric thresholds to classify alignment scores into negative, neutral, and positive zones, further ensuring reproducibility. Scores for each analytical pillar are aggregated to produce a composite deterministic score.

f) outputting composite score and provenance (Step 212): The composite score, along with provenance metadata identifying elements such as corpus version, rubric element, prompt framework version, and evaluation timestamp, is output via an analytic interface. This interface supports advanced operations, including portfolio filtering, benchmarking against defined criteria or industry peers, extending research goals through dynamic rubric question generation, and visualizing results along both financial-return and sustainability-alignment axes. The combination of composite score and comprehensive provenance enables regulatory, compliance, and stakeholder audits, promoting ultimate transparency and trust in the system's scoring methodology.

This method 200 ensures that every evaluative score is deterministically reproducible, transparently supported by a complete chain of evidence, rigorously structured reasoning, and a consistent, version-controlled analytical context.

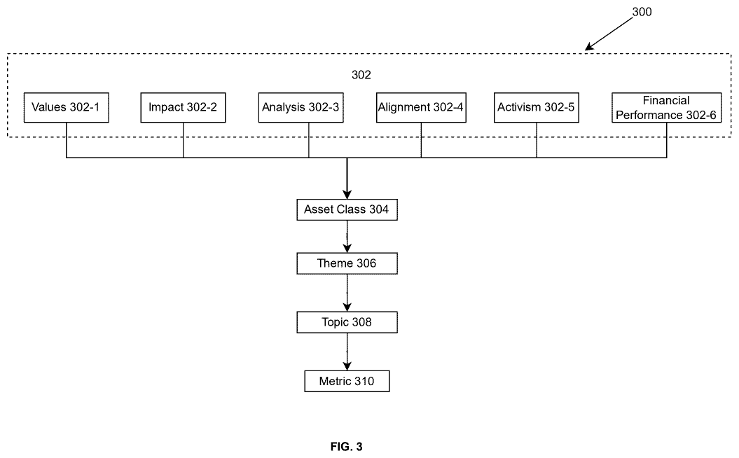

FIG. 3 illustrates a hierarchical diagram of the rubric framework 300, organized by asset class, theme, topic, and pillars such as values, impact, analysis, alignment, activism, and financial performance in accordance with an exemplary embodiment of the present invention.

Pillar Organization: At the top level, the rubric framework 300 is organized by a set of plural analytical pillars, collectively referenced as 302, including: values 302-1, impact 302-2, analysis 302-3, alignment 302-4, activism 302-5, and financial performance 302-6. Each pillar 302 represents a specific evaluative dimension applied during the assessment of a security or subject of analysis.

Hierarchical Rubric: Underpinning these pillars 302 is a hierarchical rubric structure 300, which systematically organizes evaluation questions and metrics. The hierarchical rubric consists of the following subdivisions:

Asset Class 304: The initial classification organizes the analysis according to the type of security or investment, such as “public equity”, “corporate bond”, or “real estate fund”. For example, the asset class 304 could be specified as “public equity”.

Theme 306: Within each asset class, the rubric 300 is divided into themes, each representing a key focus area such as “climate change resilience”, “corporate governance”, or “supply chain integrity”. For example, a theme 306 under public equity could be “climate change resilience”.

Topic 308: Under each theme, the rubric 300 breaks down further into specific topics, such as “scope 1 & 2 carbon emissions”, “board independence”, or “supplier labor practices”. For instance, topic 308 could be “scope 1 & 2 carbon emissions”.

Metric 310: Finally, each topic is assessed using one or more metrics, which serve as the basis for evidence gathering and scoring. The metric 310 may include quantitative indicators, such as “annual emissions in metric tons”, or qualitative measures, such as “policy disclosures” or “remediation actions taken”.

In one example, to evaluate a company's alignment with sustainability goals, the rubric 300 may select the pillar “impact” 302-2. Within the rubric 300, the asset class 304 would be “public equity”. The theme 306 would be “climate change resilience”. The topic 308 would be “scope 1 & 2 carbon emissions”. The metric 310 could be “annual reported emissions (metric tons of CO2)”.

Each pillar 302 is linked to this hierarchical rubric 300, ensuring structured, repeatable, and comparable analysis across multiple securities and evaluation types. The framework 300 enables traceability from high-level composite scores down to specific metrics, supporting the reproducibility, transparency, and auditability.

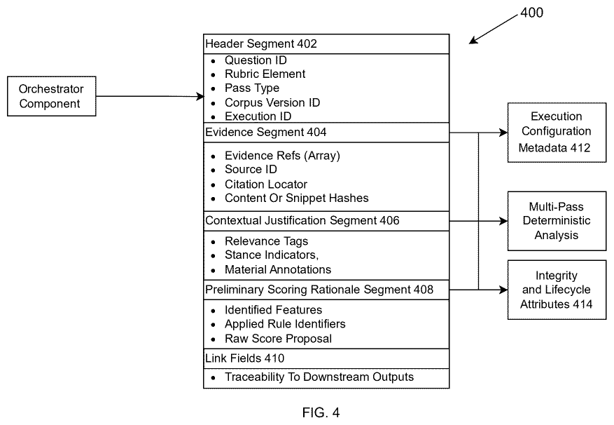

FIG. 4 illustrates a scratch-pad reasoning and scoring module 400 in accordance with an exemplary embodiment of the present invention. The scratch-pad reasoning and scoring module 400 is configured to capture, structure, and persist intermediate reasoning generated during the evaluation of rubric questions, enabling end-to-end traceability to corpus sources and deterministic re-execution under controlled inference settings. Each scratch-pad reasoning and scoring module 400 is instantiated for a specific rubric question under an active corpus snapshot and execution configuration so that the reasoning, evidence selection, and preliminary rationale are bound to a fixed analytical context and can be reproduced across runs. The scratch-pad reasoning and scoring module 400 is externalized as a structured data object rather than an ephemeral, free-form explanation, stabilizing storage, programmatic retrieval, and downstream use by the multi-pass synthesis and scoring engines while preserving a complete provenance chain.

The scratch-pad reasoning record 400 includes a header segment 402 that stores identifiers anchoring the record to the analytical context, including at least a Question ID, Rubric Element ID, Pass Type, Corpus Version ID, and Execution ID, which together uniquely link the record to a rubric node, an analysis stage, a frozen corpus snapshot, and a particular evaluation run. The record further comprises an evidence segment 404 that maintains an array of evidence References (Refs), each of which points to a source entity within the fixed corpus via a stable Source ID, a Citation Locator, and Content or Snippet Hashes, enabling unambiguous trace-back to the exact evidence universe used in the evaluation. A contextual justification segment 406 captures structured fields that describe why the referenced evidence is pertinent to the rubric question, including relevance tags, stance indicators, and material annotations, which constrain the reasoning into a normalized representation supportive of audit and filtering. A preliminary scoring rationale segment 408 records intermediate reasoning outputs aligned with rubric rules, such as identified features, applied rule identifiers, and a raw score proposal, while deferring final calibrated classification to the rubric-based scoring engine, thereby separating reasoning from classification to enhance stability and reviewability.

The scratch-pad reasoning and scoring module 400 additionally includes link fields 410 that associate the record with one or more synthesized statement identifiers emitted by the multi-pass deterministic analysis, establishing bidirectional traceability between the intermediate reasoning and the structured evidentiary outputs ultimately consumed by the scoring engine. Execution configuration metadata 412 persisted with the record and includes identifiers for the model and prompt framework, as well as decoding parameters and determinism controls such as temperature settings, sampling flags, seed values, and batch-invariance configuration, which together allow deterministic reconstruction of model outputs for identical inputs. Integrity and lifecycle attributes 414, including creation timestamps, content hashes, and state flags, provide immutability guarantees for finalized reasoning and support longitudinal reproducibility and audit.

During operation, an orchestrator component creates the scratch-pad reasoning and scoring module 400 at entry to a rubric question, populating the header segment 402 from the active rubric node and the corpus snapshot, and binding the record to the current Execution ID for the session. A structured prompt then directs the large-language model to populate the evidence segment 404 and the contextual justification segment 406 before emitting any scoring rationale, thereby enforcing ordered analytical stages and structured intermediate output rather than a free-form monologue. The orchestrator persists execution configuration metadata 412 alongside the newly written reasoning segments and computes integrity and lifecycle attributes 414. Afterward, the multi-pass synthesizer consumes the scratch-pad reasoning and scoring module 400 to produce source-traceable synthesized statements for the relevant analysis pass, while updating the link fields 410 to reflect downstream outputs. This design ensures that every synthesized evidentiary statement and the resulting score can be traced back, through explicit record linkages, to the exact evidence and reasoning steps applied under a known execution configuration.

For provenance conformance, each scratch-pad reasoning and scoring module 400 is modeled as a PROV Entity generated by an LLM evaluation activity and associated with one or more Agents, such as the model runtime and orchestration service, with used relationships targeting the specific corpus entities referenced in the evidence segment 404. The Execution ID and prompt framework version are represented as plan or configuration entities associated with the producing activity, enabling third-party auditors to reconstruct the steps and parameters used to create the record and link it to synthesized statements and scores. This representation permits export using standard PROV serializations so that provenance relationships, such as was generated by, used, was attributed to, and was associated with, span records, synthesized statements, and corpus sources, can be exchanged in an interoperable manner.

To support deterministic reproduction of intermediate reasoning, the execution configuration metadata 412 captures seed values, decoding strategy, and batch-invariance settings sufficient to neutralize nondeterminism arising from dynamic batching and reduction-order variance in transformer kernels. The inference stack employs batch-invariant kernels for reduction-heavy operations and disables stochastic sampling, allowing repeated executions of the same prompt and corpus state to yield bitwise-identical intermediate reasoning outputs when run under the same configuration. Persisting these parameters with the record allows users or evaluators to attribute any observed variance to controlled changes in kernels, batching, or decoding, and to quantify stability over time to support compliance or research objectives.

The scratch-pad reasoning and scoring module 400 for a “supply-chain labor policy” topic includes three Evidence Refs pointing respectively to a company disclosure, a supplier code of conduct, and a regulator notice, with contextual justification 406 tagging each item's relevance, temporal scope, and materiality. The preliminary scoring rationale segment 408 cites applicable rubric rule identifiers and records a raw alignment score proposal before calibration. While the link field 410 references a synthesized statement generated for a “Demonstrated Actions” pass, it establishes a complete chain from corpus sources through intermediate reasoning to structured evidentiary outputs.

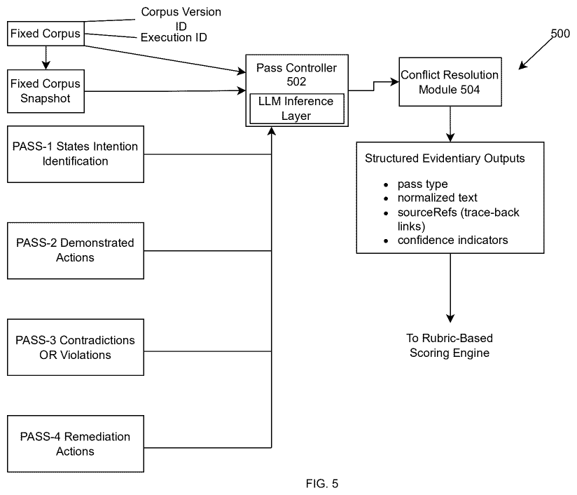

FIG. 5 illustrates a multi-pass deterministic analysis subsystem 500 that processes a fixed, version-controlled corpus to generate structured, source-traceable synthesized statements across ordered analytical passes to support the reproducibility and auditability of evaluative outcomes in accordance with an exemplary embodiment of the present invention. The multi-pass deterministic analysis subsystem 500 is orchestrated by a pass controller 502 that enforces an execution order comprising at least Pass 1: Stated Intention Identification, Pass 2: Demonstrated Actions, Pass 3: Contradictions or Violations, and Pass 4: Remediation Actions, each executed against the same frozen corpus snapshot to preserve a static analytical context. The pass controller 502 receives, for each rubric element, a scratch pad reasoning record emitted under a structured prompt framework and binds the record to a Corpus Version ID and Execution ID so that all intermediate outputs produced in a given pass are deterministically tied to the same evidence universe and inference configuration.

In Pass 1, the multi-pass deterministic analysis subsystem 500 extracts stated intentions, policies, or forward-looking commitments from disclosures and filings, consolidating them into a synthesized statement S1 that includes source identifiers and locator metadata to enable unambiguous traceback to the underlying versioned corpus entities. In Pass 2, the multi-pass deterministic analysis subsystem 500 evaluates demonstrated actions, programs, and implementations documented in reports or third-party assessments, and emits a synthesized statement S2 that describes the concrete measures taken and their temporal scope, again carrying explicit source references to maintain evidentiary integrity. In Pass 3, the multi-pass deterministic analysis subsystem 500 identifies contradictions, violations, or material controversies by matching alleged or confirmed adverse events against prior intentions and actions, applying severity and role taxonomy consistent with established controversy assessment practices to generate a synthesized statement S3 with severity and materiality annotations. In Pass 4, the multi-pass deterministic analysis subsystem 500 identifies remediation or resolution steps, including mitigation, compensation, corrective programs, or third-party audits, and emits a synthesized statement S4 that captures the nature of the remediation and its status for longitudinal monitoring of resolution over time.

To ensure deterministic behavior, the pass controller 502 applies fixed decoding strategies and seeded configurations at the LLM inference layer and employs batch-invariant operators or equivalent controls in the inference stack so that repeated executions over the same inputs yield stable, run-to-run identical synthesized statements. In one implementation, the inference environment records temperature, sampling flags, seed, batch settings, and kernel invariance options in execution metadata, which the multi-pass deterministic analysis subsystem 500 both consumers persist across passes, enabling subsequent verification of determinism and controlled replication. The multi-pass deterministic analysis subsystem 500 further includes a conflict resolution module 504 that, when Pass 3 indicates a violation and Pass 4 indicates remediation, annotates synthesized outputs with both the adverse event's assessed severity and the status of remediation, consistent with controversy methodologies in which remedial measures and resolution affect the overall assessment.

Each synthesized statement S1-S4 is stored as a structured evidentiary output with fields for Pass Type, normalized text, Source Refs, and confidence indicators, and is linked back to the corresponding scratch pad record and forward to the rubric-based scoring engine to support consistent downstream scoring and audit. The multi-pass deterministic analysis subsystem 500 maintains a provenance graph for each pass, modeling corpus items as entities and pass executions as activities, and recording used-by and generated-by relations so external auditors can reconstruct which corpus items were consumed to produce each synthesized statement.

In one example embodiment, a company asserting a supplier labor policy (Pass 1) and reporting third party audits (Pass 2) later faces a regulator notice alleging violations (Pass 3), followed by compensation and policy revision steps (Pass 4), with each pass generating a statement S1-S4 that cites the specific filings, media, and regulatory documents from the fixed corpus snapshot.

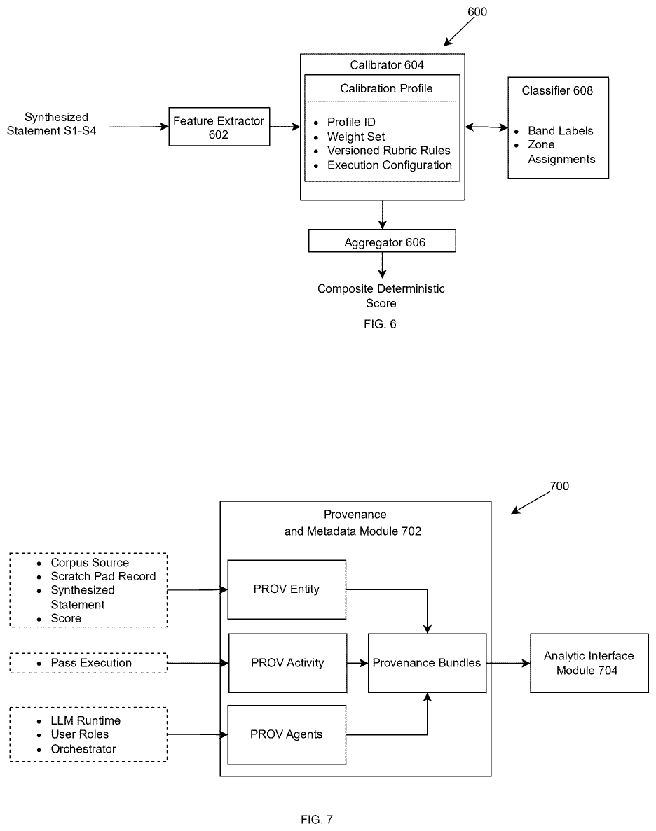

FIG. 6 illustrates a rubric-based scoring subsystem 600 configured to convert the synthesized statements generated by the multi-pass analysis into calibrated alignment scores within a defined numeric range in accordance with an exemplary embodiment of the present invention. The rubric-based scoring subsystem 600 classifies those scores into negative, neutral, and positive zones using fixed thresholds and aggregates pillar-level results into a composite score under a deterministic configuration. The rubric-based scoring subsystem 600 includes a feature extractor 602 that maps facts and annotations from synthesized statements S1-S4, such as the presence of policies, evidence of programs, severity of controversies, and status of remediation, into normalized rubric features aligned to rubric rule identifiers. A calibrator 604 then applies a fixed calibration profile that defines threshold cut points and zone boundaries for classification, ensuring that, given the same feature vector, the resulting score and zone assignment are reproducible across runs and invariant to changes in the execution environment.

The calibrator 604 computes a numeric score per pillar and classifies the score into a banded zone (for example, negative/neutral/positive or multi-band tiers), with threshold boundaries specified in the calibration profile and documented in methodology references so that end users can interpret the classification consistently. The rubric-based scoring subsystem 600 may penalize pillar scores based on controversy severity and adjust penalties or credits based on remediation evidence, reflecting industry practice that considers both the materiality of adverse events and the remedial steps taken when assigning final assessments. The pillar-level scores are aggregated by an aggregator 606 using fixed weights or a documented weighting scheme to produce a composite deterministic score, with the aggregation logic and any normalization steps held constant across revisions to support longitudinal comparability.

To further support audit and reproducibility, the rubric-based scoring subsystem 600 records the calibration profile identifier, weight set, versioned rubric rules used, and the execution configuration (for example, seed and decoding strategy when any model-assisted feature extraction is used) in provenance metadata persisted alongside the final score. The classifier 608 exposes zone assignments and band labels derived from the thresholds so that portfolio construction or screening systems can apply deterministic filters and tilts against the composite or pillar scores without ambiguity or drift. In one example, a pillar score derived from S1-S4 crosses a calibrated threshold into a less favorable band due to the severity of a controversy, but later re-enters a neutral band when validated remediation actions are recorded, with both the penalty and subsequent adjustment executed under the exact fixed calibration and logged for audit.

The rubric-based scoring subsystem 600 is designed for deterministic operation, end-to-end. The same synthesized statements and feature mappings, when passed through the same calibration profile and aggregation weights, produce identical numeric outputs and classifications, and any deviation across executions triggers a reproducibility check that attributes differences to configuration or methodology changes rather than runtime nondeterminism. When model inference is employed upstream for feature extraction, the system uses batch invariant kernels and fixed seeds to prevent batch composition and reduction order effects from altering outputs, thereby maintaining score stability across repeated runs on identical inputs. The final outputs include pillar-level and composite scores, band classifications, and provenance references to both the synthesized statements and the calibration profile so that stakeholders can reconstruct how each score was derived from specific evidence and deterministic rules.

FIG. 7 illustrates a screenshot of flow 700 between a provenance and metadata module 702 and an analytic interface module 704 that records, for each evaluation, identifiers and relationships sufficient to reconstruct the evidence, activities, agents, methodologies, and configurations involved in producing synthesized statements and scores in accordance with an exemplary embodiment of the present invention. The provenance and metadata module 702 models each corpus source, scratch pad record, synthesized statement, and score as a PROV Entity, each pass execution as a PROV Activity, and the LLM runtime, orchestrator, and user roles as PROV Agents, thereby enabling was generated by, used, and was associated with relations across the whole evaluation chain. The provenance and metadata module 702 supports named provenance bundles to encapsulate an evaluation's internal provenance and to express “provenance of provenance”, facilitating external audits that must attribute responsibility and time to both the data and the provenance package itself. Provenance records also store configuration entities for the prompt framework version, the calibration profile identifier, and inference parameters, so auditors may verify that deterministic settings, thresholds, and weights match those used during the original evaluation. The analytic interface module 704 exposes these records in a human-readable view and in machine-readable PROV serializations, allowing regulators and stakeholders to traverse from any displayed score to the underlying synthesized statements and the exact corpus sources in the fixed snapshot.

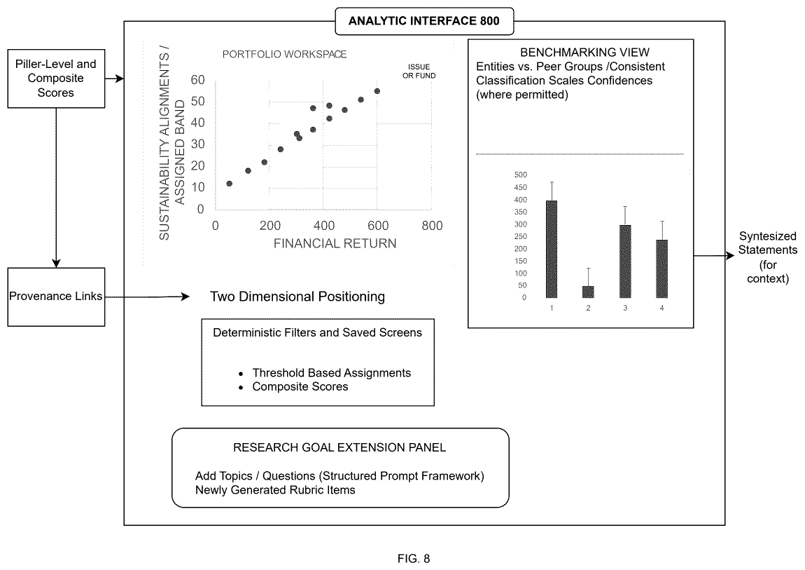

FIG. 8 illustrates an analytic interface module 800 that consumes pillar-level and composite scores, along with provenance links, to enable portfolio filtering, benchmarking, research goal extension, and two-dimensional positioning of entities along financial return and sustainability alignment axes in accordance with an exemplary embodiment of the present invention. A portfolio workspace renders a scatter plot in which the x-axis represents expected or realized financial return metrics. At the same time, the y-axis encodes sustainability alignment or calibrated bands, supporting substitution analysis and comparative positioning at the issuer or fund level. The analytic interface module 800 provides deterministic filters and saved screens based on threshold band assignments and composite scores, ensuring that the same corpus version and calibration profile yield identical filter results upon re-execution. A benchmarking view compares entities against peer groups or indices using consistent classification scales and displays confidence intervals only where methodology permits, while retaining links to synthesized statements for context. A research goal extension panel allows users to add topics or questions under the same structured prompt framework. Newly generated rubric items are tied to the active corpus snapshot and inherit the deterministic inference configuration to maintain reproducibility in subsequent analyses.

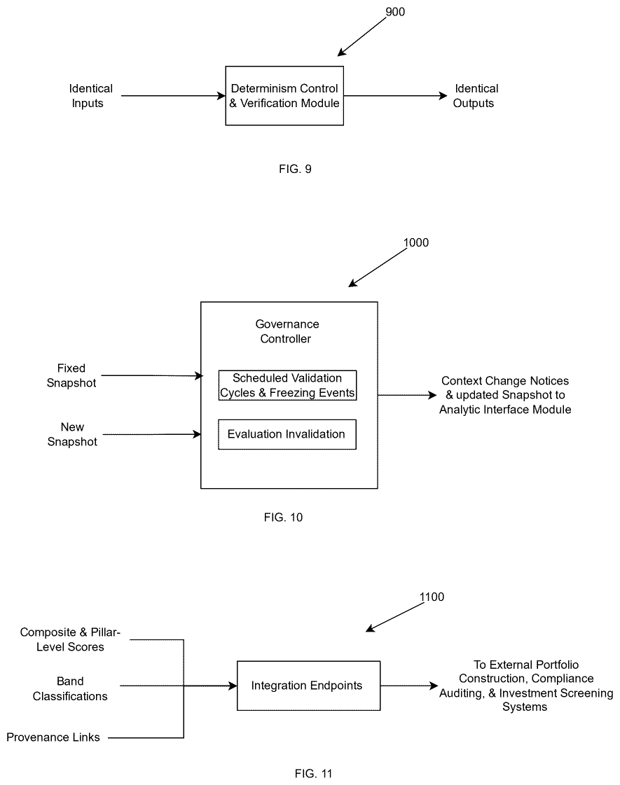

FIG. 9 illustrates a determinism control and verification subsystem 900 that enforces, records, and monitors inference and scoring configurations to achieve run-to-run identical outputs for identical inputs in accordance with an exemplary embodiment of the present invention. The determinism control and verification subsystem 900 configures inference to a fixed seed and non-sampling decoding, and employs batch-invariant kernels or equivalent numerical controls to eliminate divergence caused by variable batch composition and reduction-order differences common in transformer operations. In one scenario, the determinism control and verification subsystem 900 standardizes kernel tiling and attention reduction strategies so that a request's outputs do not vary with server load, with empirical validation demonstrating 1,000 of 1,000 identical completions under controlled settings. The determinism control and verification subsystem 900 logs determinism parameters per run, including temperature, sampling flags, seeds, batch sizing, and kernel invariance toggles, into the provenance record to support post hoc verification and incident analysis. A reproducibility metrics panel quantifies variance across repeated executions of identical evaluations and flags deviations beyond tolerance, attributing differences to configuration or environment changes rather than stochastic effects when batch invariance is enforced. Where upstream model assistance is used in feature extraction, the determinism control and verification subsystem 900 applies the same determinism controls and records the model and configuration identifiers so that feature vectors and downstream scores are identical across re-runs.

FIG. 10 illustrates a governance controller 1000 that manages versioned snapshots of the fixed corpus through lifecycle, preserving the analytical context used in any evaluation and preventing retroactive mutation of evidence in accordance with an exemplary embodiment of the present invention. The governance controller 1000 implements collections and derivations in the provenance model so that each fixed snapshot is a named collection of source entities with stable identifiers and hashes, and each new snapshot is recorded as a derived entity with its own validation and timestamp metadata. When a new fixed snapshot is published, the governance controller 1000 invalidates dependent evaluations tied to prior snapshots for forward-looking decisions, while retaining historical comparability by preserving provenance references to the original snapshot. Scheduled validation cycles govern ingestion, curation, and freezing events, with the determinism configuration and methodology versions documented to ensure that longitudinal analyses are interpretable and reproducible over time. The governance controller 1000 integrates with the analytic interface module to display context change notices and offers re-evaluation jobs that re-run analyses under the updated snapshot and recorded deterministic settings.

FIG. 11 illustrates integration endpoints 1100 that expose composite and pillar-level scores, classifications, and provenance links to external portfolio construction, compliance auditing, and investment screening systems in accordance with an exemplary embodiment of the present invention. Portfolio tools may consume deterministic score feeds and band classifications to implement rules-based filters, score-tiled optimizations, or peer-aware benchmarking consistent with sustainable investment objectives. Compliance and audit systems access a permissioned audit interface that returns human-readable chains from scores back to synthesized statements and corpus sources, together with machine-readable provenance bundles for formal review and recordkeeping. Integration contracts specify versioned calibration profiles, rubric identifiers, and corpus snapshot IDs to ensure that consuming systems can reconcile methodology and context across reporting periods and reproduce results on demand. The integration endpoints 1100 are designed to preserve determinism guarantees end-to-end by propagating execution configurations and snapshot references, thereby enabling external environments to replicate evaluations and confirm stability for regulatory or fiduciary purposes.

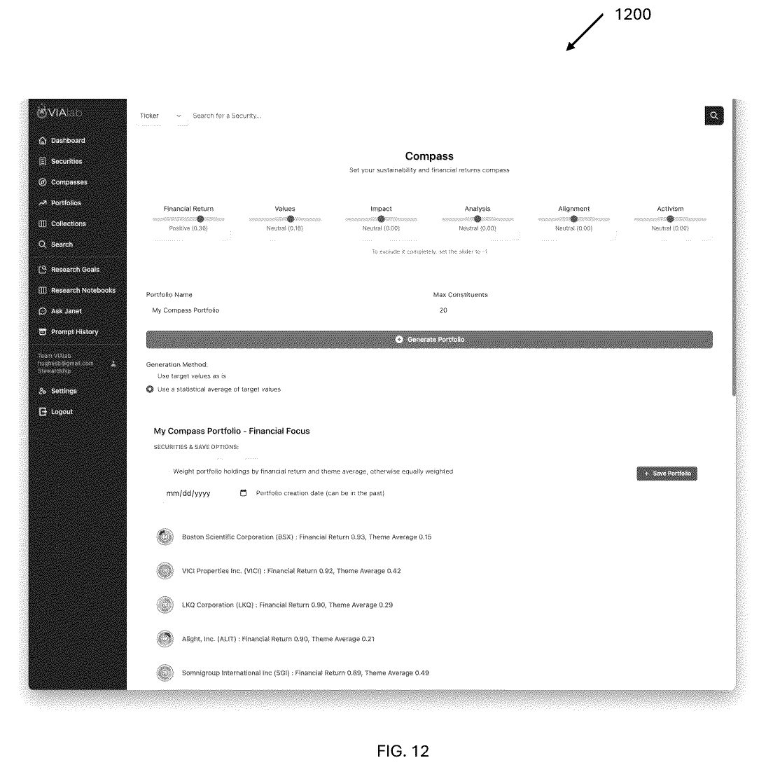

FIG. 12 illustrates a screenshot of an analytic interface module 1200, showcasing a compass, in accordance with an exemplary embodiment of the present invention. Users may set target alignment levels via sliders for six pillars: Financial Return, Values, Impact, Analysis, Alignment, and Activism, each ranging from −1 (exclude) to +1 (prioritize), with neutral at 0.00. A Portfolio Name (“My Compass Portfolio”) and Max Constituents (20) are also specified, with generation options to use target values directly or as a statistical average.

An active generate portfolio button is also shown. Further, the generated exemplary portfolio “My Compass Portfolio-Financial Focus” lists one or more securities with icons and scores. Options include weighing by financial return and theme average, a date field (mm/dd/yyyy), and a + Save Portfolio button.

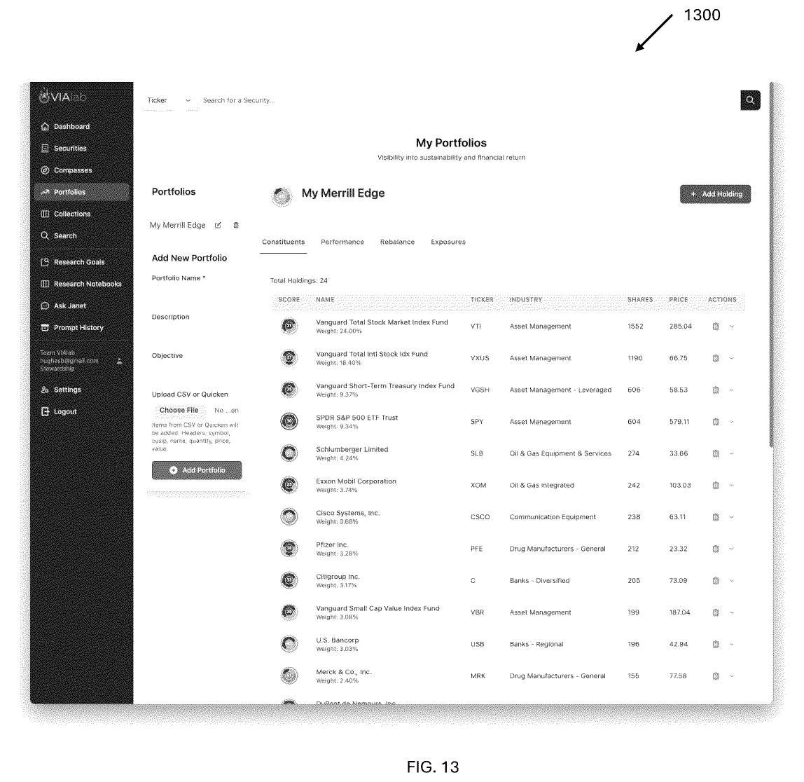

FIG. 13 illustrates a screenshot of an analytic interface module 1300, showcasing my portfolios in accordance with an exemplary embodiment of the present invention. The analytic interface module 1300 depicts a selected My Merrill Edge portfolio. Further, the analytic interface module 1300 displays the constituents tab for a portfolio with total holdings of 24. The holdings table lists securities with columns for score, name, ticker, industry, shares, price, and actions.

Each row includes a color-coded icon, a share count dropdown, and an action menu. A + Add Holding button is available at the top right. The left sidebar includes an Add New Portfolio form with fields for Portfolio Name, Description, Objective, and Upload CSV or Quicken file input, followed by a green+Add Portfolio button.

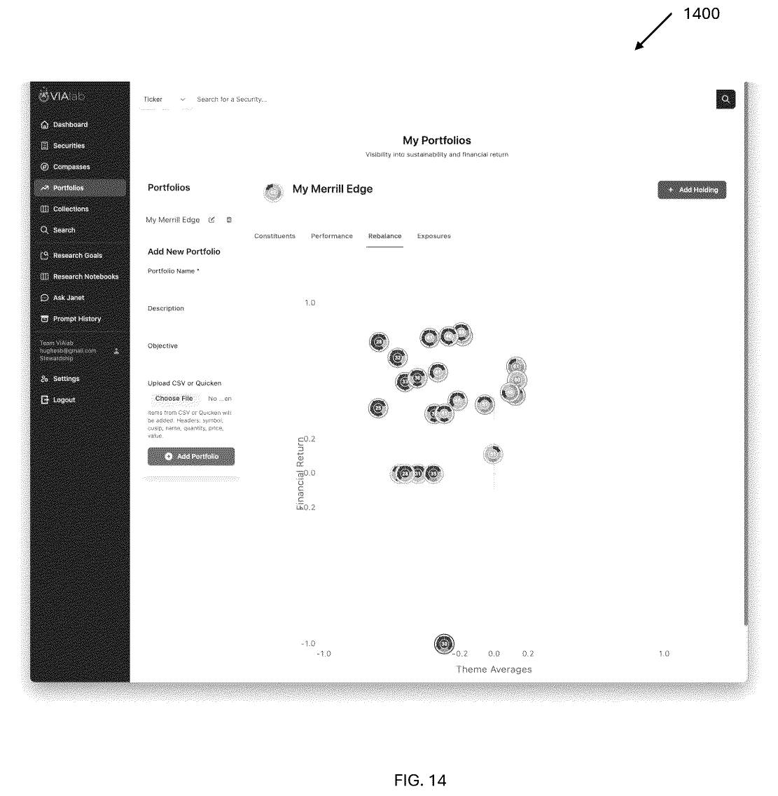

FIG. 14 illustrates a screenshot of an analytic interface module 1400, showcasing the performance tab of the selected portfolio in accordance with an exemplary embodiment of the present invention. The main view presents a scatter plot visualization of portfolio constituents along two axes: X-axis: Theme Averages (ranging from −1.0 to +1.0), and Y-axis: Financial Return (ranging from −0.2 to 1.0).

Each holding is represented by a circular bubble with a size proportional to portfolio weight (larger bubble=higher weight), a color-coded icon (green, yellow, red) indicating alignment classification, and numeric labels showing weight percentage (e.g., 24, 18, 9.97), bubbles are distributed across the plot, with most clustered in the upper-right quadrant (positive financial return and positive theme alignment), several in the upper-left (high return, negative alignment), and a few near the origin or lower regions.

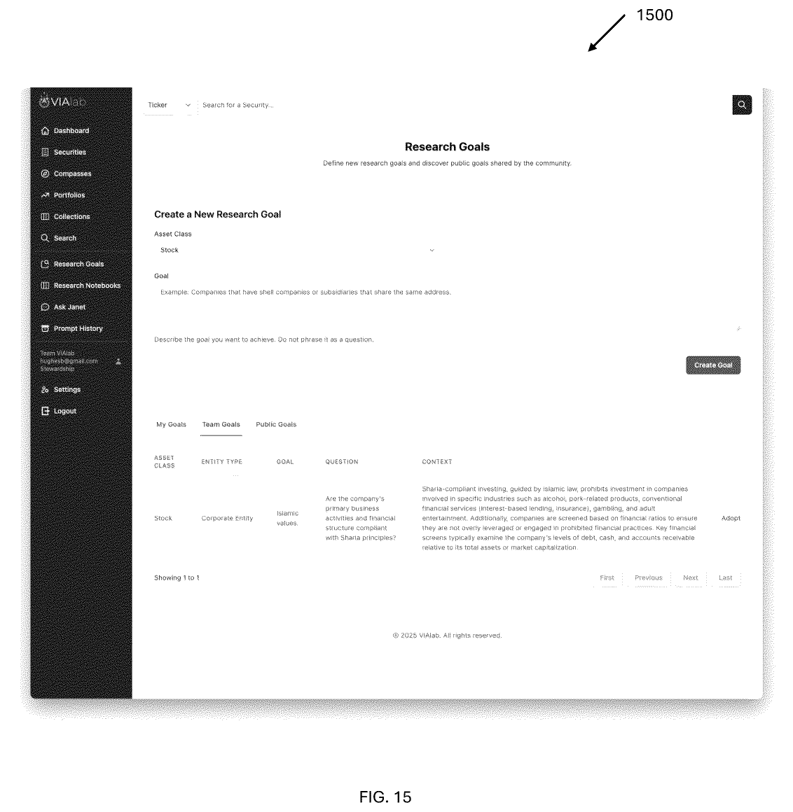

FIG. 15 illustrates a screenshot of an analytic interface module 1500 showcasing research goals for defining and discovering community-shared research goals in accordance with an exemplary embodiment of the present invention. The analytic interface module 1500 depicts “create a new research goal form”. The new research goal form includes: an asset class dropdown menu and set to stock, a goal text area with a placeholder example: “companies that have shell companies or subsidiaries that share the same address”, instructional text: “describe the goal you want to achieve. Do not phrase it as a question”, and a create goal button.

Below, the team goals tab is active, displaying a table with columns: asset class, entity type, goal, question, context

One example entry is shown: Asset Class: Stock, Entity Type: Corporate Entity, Goal: Islamic values, Question: Are the company's primary business activities and financial structure compliant with Sharia principles? and Context: Sharia-compliant investing, guided by Islamic law, prohibits investment in companies involved in specific industries such as alcohol, pork-related products, conventional financial services (interest-based lending, insurance), gambling, and adult entertainment.

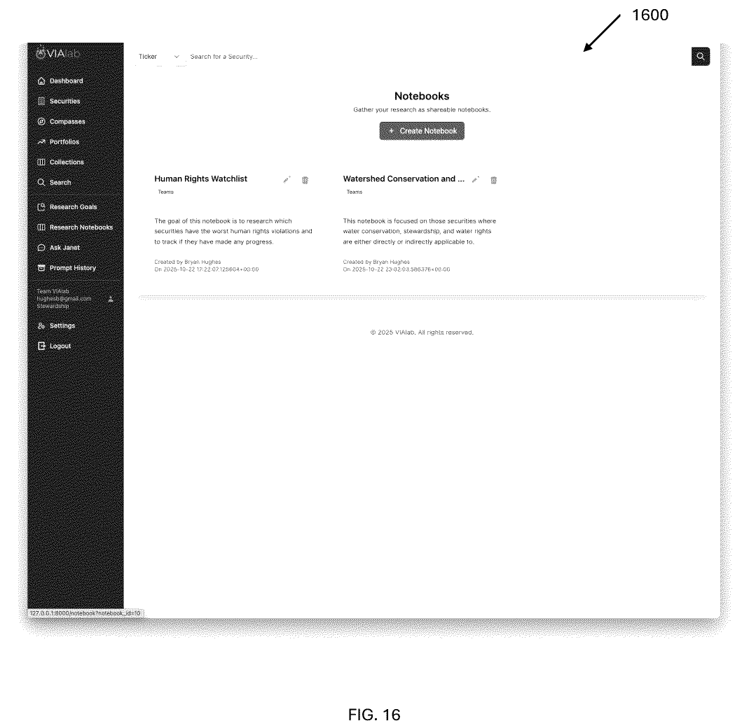

FIG. 16 illustrates a screenshot of an analytic interface module 1600 showcasing notebooks in accordance with an exemplary embodiment of the present invention. The analytic interface module 1600 displays two team-shared notebooks, “Human Rights Watchlist” to monitor severe violators and track remediation progress, and “Watershed Conservation and . . . ” focused on water stewardship and rights, both authored by a user with creation timestamps and edit/delete controls, alongside a + Create Notebook button.

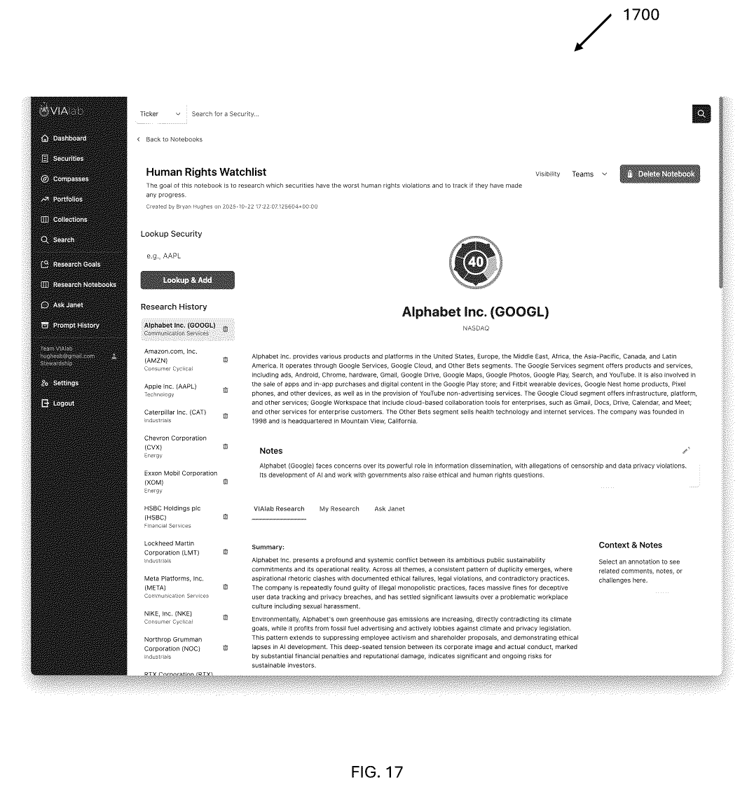

FIG. 17 illustrates a screenshot of an analytic interface module 1700 showcasing a human rights watchlist selected from notebooks in accordance with an exemplary embodiment of the present invention. The analytic interface module 1700 enables users to search and add securities via lookup & add. The research history tracks prior entries (for example, Google, Amazon). The selected Alphabet Inc. (Google) profile displays a 40 risk badge, operational summary, and critical notes. Notes highlight concerns such as censorship, AI ethics, and workplace issues. The system provides an overview of conflicts between sustainability commitments and practices, with tabs for My Research, Ask Janet, and Context and Notes.

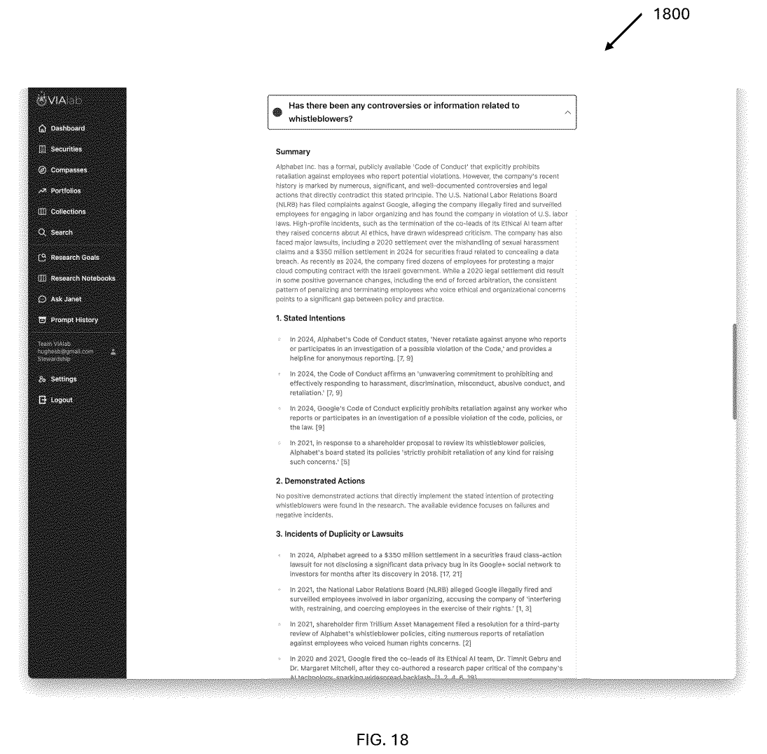

FIG. 18 illustrates a screenshot of an analytic interface module 1800 showcasing Alphabet Inc. analysis in accordance with an exemplary embodiment of the present invention. The analytic interface module 1800 provides an analysis of Alphabet Inc. (Google) in response to the query “Has there been any controversies or information related to whistleblowers?”. The system delivers a deterministic, multi-pass analysis:

Summary contrasts Alphabet's formal anti-retaliation policy with documented NLRB complaints and employee terminations.

Stated Intentions cites 2024 Code of Conduct provisions for anonymous reporting and non-retaliation.

Demonstrated Actions find no positive implementation, only failures.

Incidents of Duplicity or Lawsuits details a $350M settlement (2024), NLRB rulings (2021), and firings of ethical AI leaders (2020-2021). The structured output includes provenance metadata and supports research-goal extension, ensuring reproducible, auditable evaluations.

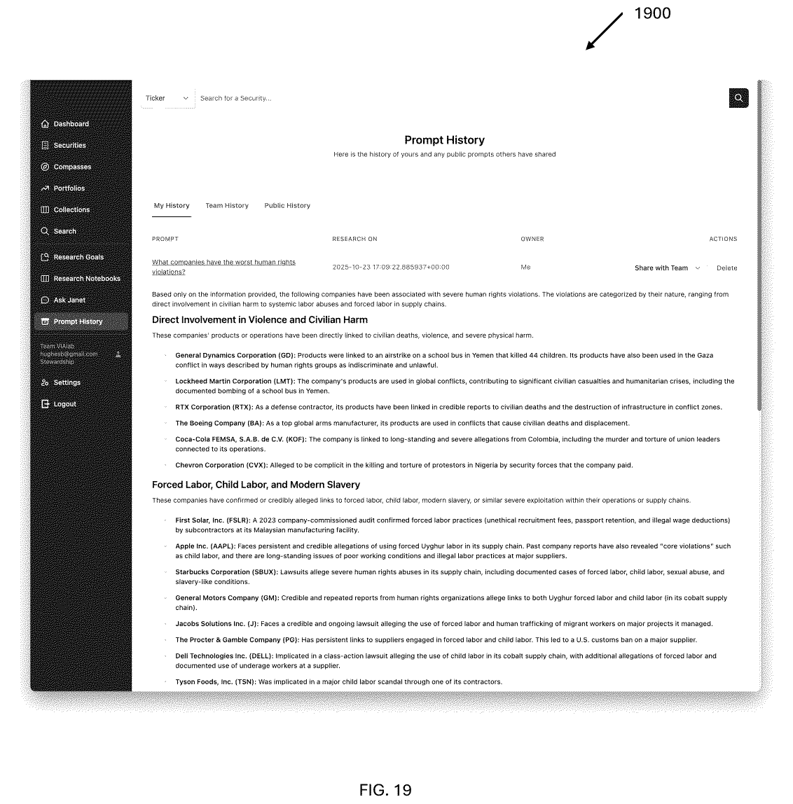

FIG. 19 illustrates a screenshot of an analytic interface module 1900 showcasing a prompt history in accordance with an exemplary embodiment of the present invention. The prompt history is displayed under the My History tab, showing a user query: “What companies have the worst human rights violations?”. The LLM-generated response categorizes severe violations into direct involvement in violence and civilian harm (for example, General Dynamics, Lockheed Martin, RTX, Boeing, Coca-Cola FEMSA, Chevron) and Forced Labor, Child Labor, and Modern Slavery (for example, First Solar, Apple, Starbucks, General Motors, Jacobs Solutions, Procter & Gamble, Dell, Tyson Foods). Each company is listed with specific allegations, evidence sources, and supply-chain links. The analytic interface module 1900 also includes share with team and delete actions options, supporting collaborative, reproducible research.

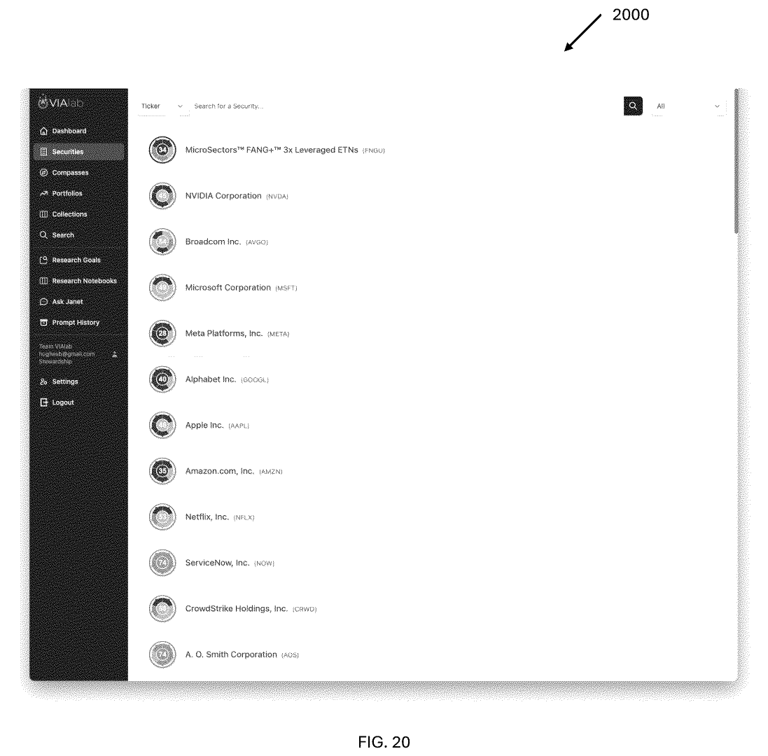

FIG. 20 illustrates a screenshot of an analytic interface module 2000 showcasing one or more securities in accordance with an exemplary embodiment of the present invention. The analytic interface module 2000 listing evaluated entities with composite alignment scores displayed in color-coded circular badges (red for negative, yellow for neutral, green for positive). Examples include MicroSectors™ FANG+™ 3× Leveraged ETNs (FNGU) at 34, NVIDIA Corporation (NVDA) at 45, Broadcom Inc. (AVGO) at 54, Microsoft Corporation (MSFT) at 49, Meta Platforms, Inc. (META) at 28, Alphabet Inc. (GOOGL) at 40, Apple Inc. (AAPL) at 46, Amazon.com, Inc. (AMZN) at 35, Netflix, Inc. (NFLX) at 53, ServiceNow, Inc. (NOW) at 74, CrowdStrike Holdings, Inc. (CRWD) at 58, and A. O. Smith Corporation (AOS) at 74, enabling rapid portfolio filtering, benchmarking, and visualization along financial-return and sustainability-alignment axes.

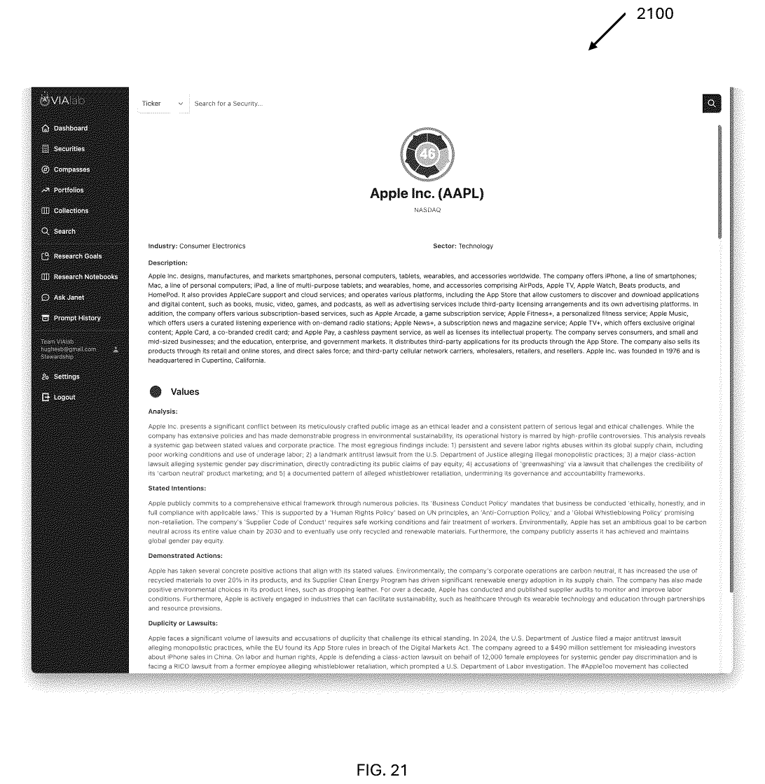

FIG. 21 illustrates a screenshot of an analytic interface module 2100 showcasing a detailed security profile for Apple Inc. in accordance with an exemplary embodiment of the present invention. The detailed security profile for Apple Inc., with a composite alignment score of 46, is displayed in a color-coded badge. The profile includes industry (consumer electronics), sector (technology), and a full company description. Under the Values pillar, the system presents a deterministic multi-pass analysis:

Analysis highlights conflicts between Apple's ethical image and labor, antitrust, and whistleblower issues.

Stated Intentions cites policies on human rights, anti-corruption, and carbon neutrality.

Demonstrated Actions notes progress in recycled materials and supplier audits.

Duplicity or Lawsuits lists DOJ antitrust suits, EU fines, and labor violation settlements, ensuring reproducible scoring with provenance metadata.

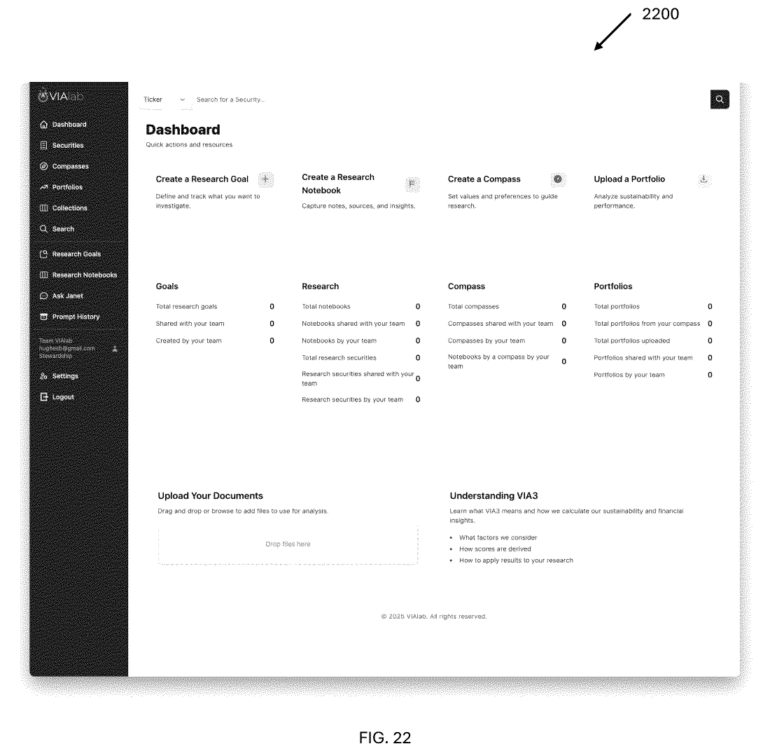

FIG. 22 illustrates a screenshot of an analytic interface module 2200 showcasing a dashboard providing quick access to core functions via action cards in accordance with an exemplary embodiment of the present invention. The action cards include creating a research goal, creating a research notebook, creating a compass, and uploading a portfolio. Summary panels display zero counts for Goals, Research (notebooks, securities), Compass, and Portfolios (shared, team-created, uploaded). An upload your documents drop zone enables drag-and-drop file ingestion for analysis, while the understanding panel explains sustainability scoring methodology, supporting integration of user-provided data into the version-controlled corpus.

1. A computer-implemented method for generating reproducible evaluative scores for a security, comprising:
receiving verified data describing the security, the data including at least one of financial, regulatory, sustainability, or accredited third-party information;
storing the verified data in a fixed and version-controlled corpus, defining a static analytical context that maintains a known universe of evidence for evaluation;
executing, by one or more processors, a large-language-model operating under a structured prompt framework that applies a rubric hierarchy organizing evaluation questions by asset class, theme, and topic aligned to plural pillars including Values, Impact, Analysis, Alignment, Activism, and Financial Performance, and directing a controlled scratch-pad reasoning process that records intermediate reasoning data representing extracted evidence and preliminary interpretations;
performing a multi-pass deterministic analysis of the fixed corpus including identification of stated intentions, demonstrated actions, contradictions or violations, and remediation actions, the passes producing structured synthesized statements as reproducible evidentiary outputs;
applying a rubric-based scoring engine that converts the synthesized statements into calibrated alignment scores within a defined numeric range and aggregates the scores across the pillars to produce a composite deterministic score; and
outputting the composite score and provenance metadata through an analytic interface supporting at least one of portfolio filtering, benchmarking, research-goal extension, or visualization of entities along financial-return and sustainability-alignment axes.

2. The method of claim 1, wherein the structured prompt framework directs the large-language model through ordered analytical stages, including context interpretation, evidence extraction, intermediate reasoning recording, and rubric application.

3. The method of claim 1, wherein the scratch-pad reasoning process generates intermediate reasoning records comprising extracted evidence, contextual justification, and preliminary scoring rationale as structured data objects.

4. The method of claim 1, wherein the multi-pass deterministic analysis includes at least four passes, respectively identifying stated intentions, demonstrated actions, contradictions or violations, and remediation actions, each pass producing synthesized statements traceable to corpus sources.

5. The method of claim 1, wherein the rubric-based scoring engine applies calibration logic defining fixed numeric thresholds that classify alignment scores into negative, neutral, and positive zones to ensure reproducible classification outcomes.

6. The method of claim 1, wherein the provenance metadata includes identifiers for corpus version, rubric element, prompt-framework version, and timestamp to permit reconstruction of prior evaluations.

7. The method of claim 1, wherein the fixed corpus is maintained as a version-controlled dataset updated on defined validation cycles that preserve historical analytical contexts and deterministic reproducibility.

8. The method of claim 1, wherein the analytic interface further generates additional rubric questions or topics under the same structured prompt framework in response to user-defined research goals while maintaining deterministic reproducibility.

9. The method of claim 1, wherein the analytic interface renders a visualization of evaluated entities along financial-return and sustainability-alignment dimensions to identify comparative positioning and substitution opportunities within portfolios.

10. The method of claim 1, further comprising verifying rubric balance and output stability using expert-defined bias-control criteria to confirm consistency of deterministic scoring results.

11. A system for generating reproducible evaluative scores for a subject of analysis, comprising:
one or more processors; and
a memory storing instructions that, when executed by the processors, cause the processors to:
receive verified data describing the subject;
store the verified source information in a fixed and version-controlled corpus, defining a static analytical context that maintains a known universe of evidence for evaluation;
execute a large-language model (LLM) under a structured prompt framework that organizes evaluation questions, and directs a controlled scratch-pad reasoning process that records intermediate reasoning data representing extracted evidence and preliminary interpretations;
perform a multi-pass deterministic analysis of the fixed corpus to produce structured, synthesized statements as reproducible evidentiary outputs;
apply a rubric-based scoring engine that converts the synthesized statements into calibrated alignment scores within a defined numeric range and aggregates the scores to produce a composite score; and
output the composite score and provenance metadata through an analytic interface.

12. The system of claim 11, wherein the instructions configure the processors to direct the large-language model through ordered analytical stages, including context interpretation, evidence extraction, intermediate reasoning recording, and rubric application.

13. The system of claim 11, wherein the instructions configure the processors to generate and store intermediate reasoning records comprising extracted evidence, contextual justification, and preliminary scoring rationale as structured data objects.

14. The system of claim 11, wherein the instructions configure the processor to perform a multi-pass deterministic analysis, including at least four passes respectively identifying stated intentions, demonstrated actions, contradictions or violations, and remediation actions, each pass producing synthesized statements traceable to corpus sources.

15. The system of claim 11, wherein the instructions configure the processor to apply calibration logic defining fixed numeric thresholds that classify alignment scores into negative, neutral, and positive zones to ensure reproducible classification outcomes.

16. The system of claim 11, wherein the instructions configure the processor to generate provenance metadata including identifiers for corpus version, rubric element, prompt-framework version, and timestamp to permit reconstruction of prior evaluations.

17. The system of claim 11, wherein the instructions configure the processor to maintain the fixed corpus as a version-controlled dataset updated according to periodic validation cycles that preserve historical analytical contexts.

18. The system of claim 11, wherein the instructions configure the processor to generate additional rubric questions or topics under the same structured prompt framework in response to user-defined research goals while maintaining deterministic reproducibility.

19. The system of claim 11, wherein the instructions configure the processor to render a visualization of evaluated entities along financial-return and sustainability-alignment dimensions to identify comparative positioning and substitution opportunities within portfolios.

20. The system of claim 11, wherein the instructions configure the processor to integrate deterministic scoring outputs with portfolio construction, compliance auditing, or investment-screening applications executed within an external analytics environment.

21. The system of claim 11, wherein the instructions configure the processor to provide an audit interface enabling retrieval of synthesized statements and provenance metadata in human-readable form for regulatory or stakeholder verification.

22. The system of claim 11, wherein the instructions configure the processor to execute the structured prompt framework across distributed computing resources while maintaining deterministic reproducibility across executions.

23. The system of claim 11, wherein the instructions configure the processor to manage corpus version governance by archiving prior corpus states and invalidating dependent evaluations when a new corpus version is introduced.

24. The system of claim 11, wherein the instructions configure the processor to record and display reproducibility metrics quantifying variance across repeated executions of identical evaluations.

25. The system of claim 11, wherein the instructions configure the processor to verify rubric balance and output stability using expert-defined bias-control criteria and automatically log corresponding consistency assessments within the provenance metadata.

26. A system for generating an evaluative score for a subject of analysis, comprising:
one or more processors; and
a memory storing instructions that, when executed by the processors, cause the processors to:
receive data describing the subject from one or more information sources;
store the data in a corpus for use during analysis;
apply a large-language model to the corpus to extract information relevant to at least one evaluative criterion;
generate one or more intermediate analytical outputs based on the extracted information; and
produce, from the intermediate analytical outputs, an evaluative score representing an assessment of the subject.
